(19) United States
(12) Patent Application Publication
(10) Pub. No.: US 2010/0119975 A1
(43) Pub. Date: May 13, 2010

(54) COMPOSITION FOR FORMING MICROPATTERN AND METHOD FOR FORMING MICROPATTERN USING THE SAME

(76) Inventors: Kazumichi Akashi, Shizuoka (JP); Yoshiharu Sakurai, Shizuoka (JP); Tomonori Horiba, Shizuoka (JP)

Correspondence Address: AZ ELECTRONIC MATERIALS USA CORP.;ATTENTION: INDUSTRIAL PROPERTY DEPT., 70 MEISTER AVENUE, SOMERVILLE, NJ, 08876, US

(21) Appl. No.: 12/452,522

(22) PCT Filed: Jun. 26, 2008
(86) PCT No.: PCT/JP2008/061619

§ 371 Date: Jan. 6, 2010

(30) Foreign Application Priority Data
Jul. 11, 2007 (JP) 2007-182152

(51) Int. Cl. G03C 1/725

(52) U.S. Cl. 430/286.1

(57) ABSTRACT

The present invention provides a fine pattern-forming composition and a fine pattern-forming method. This fine pattern-forming composition enables a pattern of high aspect ratio to be made finer than a limit of resolution determined by the wavelength of light for exposure. The composition contains a water-soluble resin and a water-containing solvent, and has a kinetic viscosity ν at 25° C. in the range of 10 to 35 mm²/s and a solid content C satisfying the condition that the ratio ν/C of the kinetic viscosity ν to the solid content C is in the range of 0.5 to 1.5 mm²/s/wt %. By use of this composition, a resist pattern having an aspect ratio of 4 to 15 or having a thickness of 2 μm or more can be further miniaturized.

### TECHNICAL FIELD

The present invention relates to a fine pattern-forming composition. In manufacture of a semiconductor device, this composition can be used for resist pattern formation in which a beforehand produced resist pattern is processed to reduce the isolation size or hole size and thereby to obtain a finer pattern. This invention also relates to a pattern-forming method employing the composition.

### BACKGROUND ART

In the field of semiconductor devices, it has been desired to downsize, thin down and lighten the products. Accordingly, semiconductor devices have been studied to increase the integration density and the fineness. Generally in manufacturing a semiconductor device, a fine resist pattern is formed by photolithographic processes and then used as a mask in etching of various base substrates, in ion-doping to the substrates and in electrolyte plating for forming metal wiring. For miniaturizing the wiring and the like on the semiconductor device, it is, therefore, very effective to improve the photo-lithographic processes for resist pattern formation.

The photolithographic processes generally comprise the steps of resist coating, masking, exposure and development. In order to obtain a fine pattern, the exposure is preferably performed by use of light in short wavelength region. However, short-wavelength light sources are very expensive and hence unfavorable in view of the production cost. Further, it is difficult for the photolithographic processes including conventional exposure to form a resist pattern finer than a limit determined by the wavelength of light for exposure.

To cope with this problem, it has been vigorously studied to develop a method to form a resist pattern which is practically miniaturized from pattern manufactured by conventional method. The conventional method includes a known positive- or negative-working photosensitive resin composition and a pattern-forming apparatus not an expensive one but a widely used one. As one of the methods for effectively miniaturizing the resist pattern, there is proposed (for example, in Patent documents 1 to 6) a technique comprising the steps of: forming a pattern by a conventional method from a known photosensitive resin composition, for example, from a chemically amplified photoresist; over coating the formed resist pattern with a fine pattern-forming composition containing a water-soluble resin; heating and/or exposing to light so that acid generated from the resist or contained in the resist is diffused into the covering layer, and thereby crosslinking and hardening the covering layer in its part located near the resist pattern; and removing the non crosslinked covering layer in its part, so that the pattern is thickened to narrow the pattern width and consequently to reduce the isolation size or hole size of the resist pattern. In this way, the proposed technique substantially miniaturizes the resist pattern, and the thus-obtained pattern is virtually finer than a limit of resolution.

The technique described in Patent documents is explained below with reference to the attached drawings. First, a resist composition is coated on a substrate 1 by a known method to form a resist layer 2 [FIG. 1(a)]. The formed resist layer 2 is fabricated by conventional photolithography to form a resist pattern 21 [FIG. 1(b)]. The resist pattern 21 is then fully coated with a fine pattern-forming composition to form a covering layer 3 [FIG. 1(c)]. Finally, the substrate is heated to cause crosslinking reaction between the resist pattern and the fine pattern-forming composition, so that a modified covering layer 31 is formed on the resist pattern to thicken the pattern [FIG. 1(d)]. Instead of heating, the covering layer can be exposed to visible or UV light to cause the crosslinking reaction. In this way, the dimension of space in a line-and-space pattern, in a trench pattern, in a dot pattern or in a hole pattern can be reduced.

The aforementioned pattern-forming method is generally applied to a relatively thin resist pattern having a thickness of not more than 1 μm or to a resist pattern having an aspect ratio of less than 4. Here, the “aspect ratio” of the resist pattern means a ratio D/W between the thickness of resist pattern (D: depth of the space or the contact hole) and the gap width of pattern (W: width of the space or diameter of the contact hole) [FIG. 2]. On the other hand, however, the above pattern-forming method is unsuitable for a thick resist pattern having a thickness of not less than 2 μm or for a resist pattern having a high aspect ratio, because that pattern is often inclined [FIG. 3(i)] or crushingly transformed [FIG. 3(ii)] as shown in FIG. 3. Further, if the method is applied to a fine resist pattern having a high aspect ratio, bubbles 4 referred to as “voids” are liable to appear in the spaces or in the contact holes and, as a result, the resist pattern cannot be evenly thickened [FIG. 4(c1), (d1)]. Furthermore, the spaces and the contact holes are often so unevenly or insufficiently coated and filled with the fine pattern-forming composition that the pattern is unsatisfactorily buried with the composition [FIG. 4(c2), (d2)].

[Patent document 1] Japanese Patent Laid-Open No. H5 (1993)-241348
[Patent document 2] Japanese Patent Laid-Open No. H6 (1994)-250379
[Patent document 3] Japanese Patent Laid-Open No. H10 (1998)-73927
[Patent document 4] Japanese Patent Laid-Open No. H11 (1999)-204399
[Patent document 5] International Patent Publication W02005/08340
[Patent document 6] Japanese Patent Laid-Open No. 2001-109165

### DISCLOSURE OF INVENTION

### Problem to be Solved by the Invention

It is an object of the present invention to provide a fine pattern-forming composition capable of improving the above problems, and also to provide a pattern-forming method employing the composition. As a result, the present invention makes it possible to provide a semiconductor device or the like which comprises a fine pattern formed by the above pattern-forming method and hence which has excellent characteristics.

### Means for Solving Problem

The present invention resides in a fine pattern-forming composition containing a water-soluble resin and a water-containing solvent, characterized by having ν is in the range of 10 to 35 mm²/s and a ratio ν/C is in the range of 0.5 to 1.5 mm²/s/wt %, wherein said ν is a kinetic viscosity at 25° C. and said C is a solid content of the composition.

The present invention also resides in a fine pattern-forming method comprising the steps of:

forming on a substrate a resist pattern of photoresist having an aspect ratio of 4 to 15 or having a thickness of 2 μm or more;

coating said pattern with the fine pattern-forming composition according to any of claims 1 to 11, to form a covering layer;

heating said covering layer and said resist pattern so as to diffuse acid from the resist pattern and thereby to crosslink and harden the covering layer in its part located near the resist pattern; and then

developing said heated covering layer with water.

### EFFECT OF THE INVENTION

The present invention provides a fine pattern-forming composition excellent in coating and filling spaces and contact holes of a resist pattern having an aspect ratio of 4 to 15 or having a thickness of 2 μm or more. The spaces and contact holes can be precisely and densely coated and filled with the component, and accordingly the resist pattern can be accurately miniaturized. As a result, a pattern finer than a limit determined by the wavelength of light for exposure can be successfully and economically manufactured. The fine resist pattern obtained thus can be used as a mask to form a miniaturized pattern on a semiconductor substrate, and hence a semiconductor device or the like with fine pattern can be readily produced in a high yield.

If the fine pattern-forming method according to the present invention is applied to dry etching, wet etching, ion implant or metal plating, a pattern of high aspect ratio can be made finer than a limit determined by the wavelength of light for exposure.

### BRIEF DESCRIPTION OF THE DRAWINGS

FIG. 1 schematically illustrates steps of the method in which a resist pattern is thickened with a fine pattern-forming composition to narrow the width between the pattern lines and thereby to virtually miniaturize the resist pattern.

FIG. 2 is a sectional view schematically illustrating a resist pattern coated with a fine pattern-forming composition.

FIG. 3 shows conceptual views schematically illustrating resist patterns formed by a conventional method.

FIG. 4 shows conceptual views schematically illustrating resist patterns coated with a fine pattern-forming composition according to a conventional method.

### BRIEF DESCRIPTION OF THE NUMERALS

1: substrate
2: resist composition
21: resist pattern
3: fine pattern-forming composition
31: covering layer
4: void

### BEST MODE FOR CARRYING OUT THE INVENTION

### Fine Pattern-Forming Composition

The fine pattern-forming composition according to the present invention contains a water-soluble resin and a solvent. Further, the composition can contain other optional components. The components and the characteristics of the composition are described below in detail.

### (1) Water-Soluble Resin

The pattern-forming composition of the present invention contains a water-soluble resin. There is no particular restriction on the water-soluble resin, provided that the resin is soluble in a solvent described later and that the resin can be crosslinked to form a covering layer by the action of acid generated from an original resist pattern which is to be thickened to form a miniaturized pattern. Examples of the water-soluble resin include polymers comprising N-vinylpyrrolidone, vinyl alcohol, acrylate or methacrylate as a constituting unit. Examples of the polymers comprising N-vinylpyrrolidone as a constituting unit include: N-vinyl-pyrrolidone/hydroxyalkyl acrylate copolymer, N-vinyl-pyrrolidone/hydroxyalkyl methacrylate copolymer, N-vinylpyrrolidone/vinylimidazole copolymer, N-vinylpyrrolidone/vinyl acetate copolymer, N-vinylpyrrolidone/vinyl alcohol copolymer, and N-vinylpyrrolidone-vinyl melamine copolymer. The copolymer comprising N-vinylpyrrolidone as a constituting unit contains N-vinylpyrrolidone in an amount of preferably 20 to 90 mol %, more preferably 50 to 95 mol % based on all the monomers constituting the copolymer. Examples of the polymers comprising vinyl alcohol as a constituting unit are a modified polyvinyl alcohol in which hydroxyl group of polyvinyl alcohol are protected with protecting groups such as acetyl, acetal, formal and butyral. The reaction of protecting the hydroxyl group with the protecting groups such as acetyl, acetal, formal and butyral can be carried out in a known manner. Examples of the polymers comprising acrylate or methacrylate as a constituting unit include: polyacrylic acid, polymethacrylic acid, and copolymers of acrylic or methacrylic acid in combination with acrylic ester or methacrylic ester.

There is no particular restriction on the molecular weight of the water-soluble resin usable in the present invention, but the weight average molecular weight is generally 1000 to 100000, preferably 10000 to 30000, more preferably 1800 to 23000. In the present invention, the weight average molecular weight is determined based on the calibration curve obtained by measuring polyethylene oxide or polyethylene glycol as a standard sample by means of gel permeation chromatography.

In order to coat the composition thickly, it is necessary for the composition to have a high solid content. However, if the kinetic viscosity is so high that the solid content and the kinetic viscosity are not in good balance, the underlying pattern is often crushingly transformed. Accordingly, the water-soluble resin preferably has a kinetic viscosity and a solid content in good balance. From this viewpoint, polymers comprising N-vinylpyrrolidone as a constituting unit are preferred. Particularly preferred are N-vinylpyrrolidone-hydroxyalkyl acrylate copolymer, N-vinylpyrrolidone-hydroxyalkyl methacrylate copolymer, and N-vinylpyrrolidone-vinylimidazole copolymer. These water-soluble resins can be freely selected according to the purpose and the kind of resist, and two or more of them can be used in mixture.

The amount of the water-soluble resin can be freely selected, but is preferably 1 to 35 weight parts, more preferably 10 to 25 weight parts based on 100 weight parts of the fine pattern-forming composition. In consideration of preventing voids, the amount of the resin is preferably 35 weight parts or less based on 100 weight parts of the composition. On the other hand, the amount is preferably 1 weight part or more based on 100 weight parts of the composition so that the underlying pattern can be satisfyingly covered with the composition.

### (2) Solvent

The solvent contained in the fine pattern-forming composition according to the present invention dissolves the aforementioned water-soluble resin and, if needed, other additives. The solvent is, for example, water or a water-containing solvent. There is no particular restriction on the water used as the solvent, but the water is preferably subjected to distillation, ion-exchange, filtration or various adsorption treatments to remove metal ions. As the water, purified water is preferred.

A mixture of water and a water-soluble organic solvent can be employed as the solvent. There is no particular restriction on the water-soluble organic solvent, as long as it can be soluble in water in an amount of 0.1 wt % or more. Examples of the water-soluble organic solvent include: alcohols such as methyl alcohol, ethyl alcohol, n-propyl alcohol, and isopropyl alcohol (IPA); ketones such as acetone and methyl ethyl ketone; esters such as methyl acetate and ethyl acetate; ethylene glycol monoalkyl ethers such as ethylene glycol monomethyl ether and ethylene glycol monoethyl ether; ethylene glycol monoalkyl ether acetates such as ethylene glycol monomethyl ether acetate and ethylene glycol monoethyl ether acetate; propylene glycol monoalkyl ethers such as propylene glycol monomethyl ether and propylene glycol monoethyl ether; propylene glycol monoalkyl ether acetates such as propylene glycol monomethyl ether acetate and propylene glycol monoethyl ether acetate; butyric esters such as methyl butyrate and ethyl butyrate; aromatic hydrocarbons such as toluene and xylene; amides such as N,N-dimethylacetamide and N-methylpyrrolidone, lactones such as γ-butylolactone; and non-protonic polar solvents such as N,N-dimethylformamide and dimethyl sulfoxide. Preferred are lower alcohols of C₁ to C₄ such as methyl alcohol, ethyl alcohol, n-propyl alcohol, isopropyl alcohol and isobutanol, and non-protonic polar solvents such as N,N-dimethylformamide and dimethyl sulfoxide. These solvents can be used in single or in mixture of two or more. The fine pattern-forming composition contains these solvents in such amounts that they do not dissolve the underlying resist pattern when coated with the composition.

(3) Water-Soluble Crosslinking Agent

Any water-soluble crosslinking agent can be used in the present invention, as long as it crosslinks and hardens the water-soluble resin in the presence of acid to form a layer insoluble in a developing solution. Examples of the water-soluble crosslinking agent include melamine derivatives and urea derivatives. Examples of the melamine derivatives include melamine, methoxymethylized melamine, methoxyethylized melamine, propoxymethlized melamine, and hexamethylol melamine. Examples of the urea derivatives include urea, monomethylol urea, dimethylol urea, alkoxymethylene urea, N-alkoxymethylene urea, and ethylene urea. Concrete examples of the agent include N,N-dimethoxymethyl propylene urea and 1,3-dimethoxymethyl-4,5-dimethoxyimidazolidine. These water-soluble crosslinking agents can be used in single or in mixture of two or more. In the case where the crosslinking agent is incorporated in the fine pattern-forming composition, the amount thereof is 20 weight parts or less, preferably 0.5 to 8 weight parts based on 100 weight parts of the composition. Since the effect of miniaturization depends on the amount and kind of the water-soluble crosslinking agent, it is necessary to select the agent properly.

(4) Polyallylamine Compound

The fine pattern-forming composition according to the present invention can contain a polyallylamine compound. If the polyallylamine compound is contained in the composition, non-crosslinked part is the covering layer tends to have an increased solubility in water that it can be developed with water only. It is presumed that this is because the polyallylamine compound promotes dissolution of the water-soluble resin. Primary and quaternary amine compounds are preferably used as the polyallylamine compound, because they promote dissolution of the water-soluble resin so well that the non-crosslinked part is dissolved well in water and consequently that developing defects are reduced. Further, the polyallylamine compound can inhibit proliferation of bacteria, and hence is preferably contained in the composition.

Examples of the polyallylamine compound usable in the present invention include: primary amines of polyallylamine derivatives, dimethylammonium salts thereof, trimethylammonium salts thereof, tetramethylammonium salts thereof, dimethylethylbenzylammonium salts thereof, and quaternary amines of N-methylpyridinium salts. The polyallylamine derivatives may be allylamine polymers or copolymers with other monomers, in which the amino groups in allylamines may be partly protected with the protective groups such as alkyloxycarbonyl, aryloxycarbonyl and alkylcarbonyl. These protective groups can be introduced into the allylamines in a known manner.

The polyallylamine compound may be a copolymer of allylamine with other monomers. Examples of the other monomers include N-vinyl-2-pyrrolidone and acrylic acid. The copolymer preferably contains allylamine in a content of 50 mol % or more. The weight average molecular weight of the polyallylamine derivative is preferably 1000 to 10000, more preferably 3000 to 7000. The polyallylamine derivative having a weight average molecular weight of 1000 or more tends to improve the sectional shape, and that having a weight average molecular weight of 10000 or less tends to improve solubility of the polyallylamine derivative. In the present invention, the weight average molecular weight is determined based on the calibration curve obtained by measuring polyethylene oxide or polyethylene glycol as a standard sample by means of gel permeation chromatography. Particularly preferred is a polyallylamine derivative represented by the following formula (I):

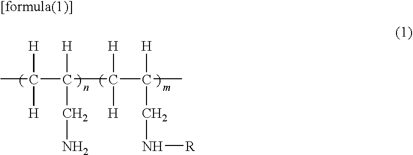

(wherein R is an alkyloxycarbonyl group, an aryloxycarbonyl group or an alkylcarbonyl group; and each of n and m is a relative number of the repeating unit under the condition of n+m=100).

In the formula (I), the alkyloxycarbonyl, aryloxycarbonyl or alkylcarbonyl group preferably comprises an alkyl group containing 1 to 3 carbon atoms. The ratio of n:m is preferably 20:80 to 80:20, more preferably 30:70 to 70:30. If n is 20 or more, the promotion of dissolution tends to be improved. However, if n is too large, the basicity of polyallylamine derivative is so strong that acid generated from the resist layer may be trapped to reduce the amount of the acid being used of crosslinking the covering layer provided on the resist. Accordingly, n is preferably 80 or less.

Preferred concrete examples of the polyallylamine include methoxycarbonylized polyallylamine.

(5) Surfactant

The fine pattern-forming composition according to the present invention can further contain a surfactant to improve coatability. Any surfactant can be employed. Examples of the surfactant usable in the present invention include (A) anionic surfactants, (B) cationic surfactants and (C) nonionic surfactants. Concrete examples of the surfactants preferably used in the present invention include: (A) alkylsulfonate, alkylbenzenesulfonic acid, and alkylbenzenesulfonate; (B) laurylpyridinium chloride and laurylmethylammonium chloride; and (C) polyoxyethylene octyl ether, polyoxyethylene lauryl ether, and polyoxyethylene acetylenic glycol ether. These surfactants are commercially available. Examples of the commercially available nonionic surfactants include Acetylenols™, (manufactured by Kawaken Fine Chemicals Co., Ltd.), Surfinols™, (manufactured by Nissin Chemical Industry Co., Ltd.), and Pionines™, (manufactured by Takemoto Oil & Fat Co., Ltd.).

(6) Other additives

The fine pattern-forming composition according to the present invention can furthermore contain any other additives unless they impair the effect of the invention. For example, a plasticizer such as ethylene glycol, glycerin or triethylglycol can be incorporated. Further, a leveling agent can be used.

The fine pattern-forming composition of the present invention contains the above components, and is characterized by the kinetic viscosity and the ratio of the kinetic viscosity to the solid content.

The composition according to the present invention has a kinetic viscosity ν at 25° C. in the range of 10 to 35 mm²/s, preferably 12 to 30 mm²/s. Further, the composition has a solid content C (wt %) satisfying the condition that the ratio ν/C of the kinetic viscosity ν to the solid content C is in the range of 0.5 to 1.5 mm²/s/wt %, preferably 0.65 to 1.25 mm²/s/wt %. If the kinetic viscosity and the ratio thereof to the solid content are in the above ranges, even a pattern of high aspect ratio or of large thickness can be coated so satisfactorily that the spaces and the holes are fully and densely filled with the composition and consequently that a homogeneous and defectless covering layer can be formed. If the kinetic viscosity and the ratio thereof to the solid content are optimized, even a pattern having an aspect ratio of 5, 6 or more or having a thickness of 3 μm, 5 μm or more can be uniformly and densely coated.

Fine Pattern-Forming Method

The fine pattern-forming method according to the present invention can be performed in a known manner except for using the fine pattern-forming composition of the present invention. This means that any known photoresist and any known resist-forming method can be used to form a resist pattern. However, the resist pattern is required to generate acid when heated so that the acid is diffused into the covering layer made of the fine pattern-forming composition. As the photoresist capable of forming such an acid-providing resist pattern, a chemically amplified photoresist is preferably employed. Any known coating method can be adopted to coat the resist pattern with the fine pattern-forming composition.

In the following description, the fine pattern-forming method according to the present invention is further explained with reference to the attached drawings. By way of example, an embodiment in which the resist pattern is formed from KrF resist is described below.

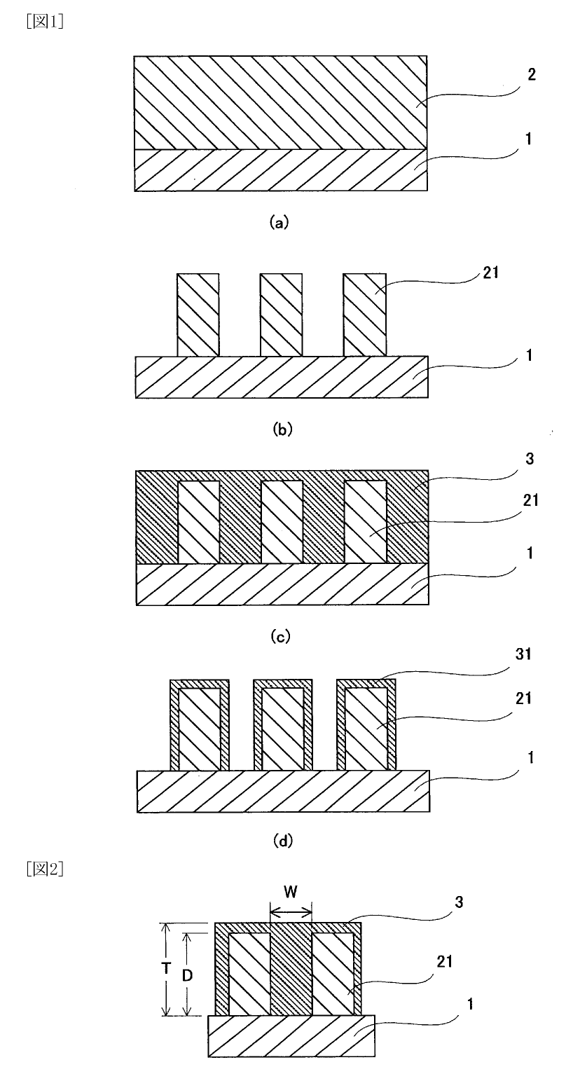

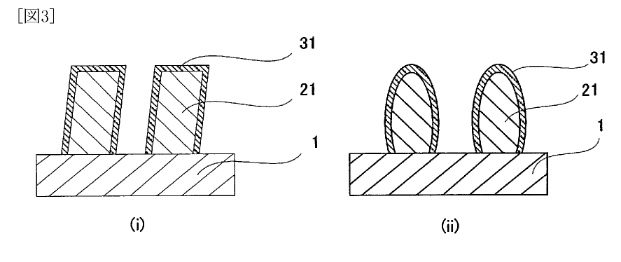

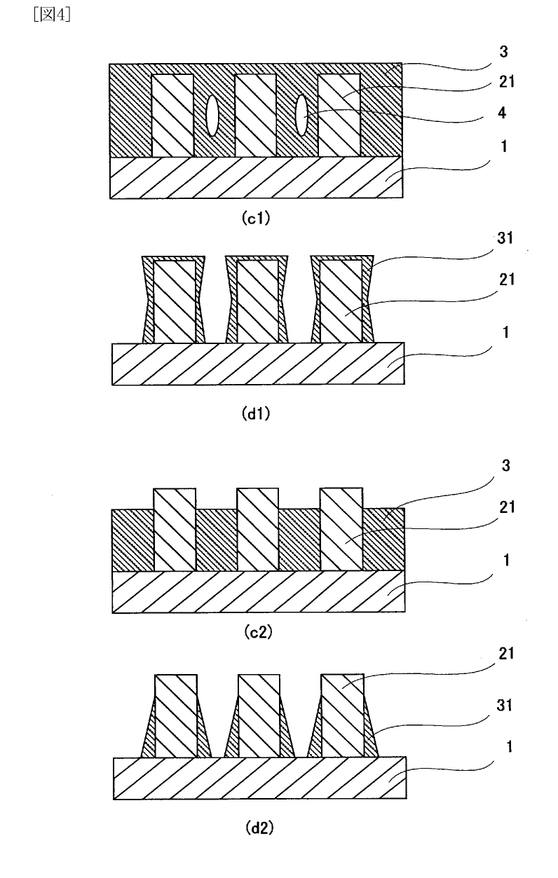

FIG. 1(a) to (d) schematically illustrates the method in which a KrF resist pattern is coated with the water-soluble resin composition of the present invention to form a modified covering layer insoluble in a developing solution. FIG. 1 shows schematic sectional views of a substrate 1, a photoresist layer 2, a resist pattern 3, a covering layer 4 and a modified covering layer 5.

First, as shown in FIG. 1(a), a KrF resist (for example, a positive-working chemically amplified photoresist) is coated on a processing substrate 1 such as a semiconductor substrate to form a photoresist layer 2. The photoresist layer 2 is then subjected to exposure through a not shown photomask by use of an exposing apparatus equipped with a KrF excimer laser light source, and thereafter is developed to form a positive resist pattern 21 [FIG. 1(b)]. After that, as shown in FIG. 1(c), the resist pattern 21 is fully coated with the fine pattern-forming composition of the present invention to form a covering layer 3. The resist pattern 21 and the covering layer 3 are then heated. When heated, the resist pattern 21 releases acid to crosslink the covering layer. Since the covering layer 3 in its part located near the resist pattern 21 is crosslinked more than that in the other part, a modified covering layer 31 insoluble in a developing solution is formed. On the other hand, the covering layer 3 in the other part is so slightly crosslinked and hardened that it can keep solubility in a developing solution. It is not clear why the crosslinking reaction of the covering layer proceeds more in the part located near the resist pattern than in the other part, but it is presumed that intermixing occurs between the surface of the resist pattern 21 and the covering layer 3 in the near part. This presumption, however, by no means restricts the present invention. Finally, the covering layer 3 in which the modified covering layer 31 insoluble in a developing solution is formed is developed, to provide the modified covering layer 31 on the surface of the resist pattern 21 [FIG. 1(d)].

As described above, the modified covering layer 31 is formed on the surface (top and side) of the resist pattern 21, and thus the width between the lines of the pattern is narrowed. As a result, the isolation size or hole size of the resist pattern is virtually made finer than a limit of resolution.

The resist pattern 21 can be formed from any radiation-sensitive resin composition, which can be freely selected from generally known and used compositions. Examples of the radiation-sensitive resin composition include: alkali-soluble resins such as novolak resins, hydroxystyrene resins and acrylic resins; quinonediazide-containing positive-working resists; and chemically amplified positive- or negative-working resists which generate acids when exposed to light and thereby which form resist patterns by the catalytic reaction of the acids. Preferred are chemically amplified positive-working resists which generate acids when exposed to light and thereby which form resist patterns by the catalytic reaction of the acids. As for the resist materials, various substances have been proposed and commercially available. Any of those known materials can be used. Also, as for the resist pattern-formation process, known methods and agents such as coating methods, exposure methods, baking methods, development methods, developing solutions and rinsing methods can be freely adopted.

In the fine pattern-forming method according to the present invention, the miniaturized pattern-forming composition of the present invention is coated to form the covering layer. The coating method can be properly selected from known coating methods such as spin-coating, spray-coating, dip-coating and roller-coating, which have been conventionally used for coating the radiation-sensitive resin composition. The formed covering layer is prebaked, if needed, to obtain a covering layer 3. The covering layer is heated at a temperature of 90 to 130° C., preferably 100 to 120° C. for 50 to 90 seconds, preferably 60 to 80 seconds. The heating temperature is preferably suitable for causing intermixing between the resist pattern and the covering layer. The thickness of the covering layer can be properly controlled by selecting various conditions such as the heating temperature and time, the radiation-sensitive resin composition and the water-soluble resin composition. These conditions are, therefore, determined according to how finely the resist pattern is designed to be miniaturized, in other words, according to how much the width of the resist pattern must be widened. The covering layer generally has a thickness of 0.01 to 100 μm from the surface of the resist pattern.

The covering layer is then developed with a developing solution so that the modified covering layer 31 formed by heating is left and that the layer in the other part is removed. Examples of the developing solution include water, a mixture of water and a water-soluble organic solvent, and an aqueous alkaline solution such as TMAH (tetramethylammonium hydroxide).

The present invention is further explained by use of the following Examples, but they by no means restrict embodiments of the present invention.

Resist pattern formation example 1

An 8-inch silicon wafer was subjected to HMDS (hexamethyldisilazane) treatment by means of a spin coater (MK-VIII™, manufactured by Tokyo Electron Limited), and coated with a positive-working photoresist (AZTX1701™, manufactured by AZ Electronic Materials (Japan) K.K.) by means of the same spin coater. After that, the resist was prebaked on a hot-plate at 140° C. for 150 seconds to obtain a resist layer 1 of approx. 5.0 μm thickness. The obtained resist layer was exposed to a KrF laser beam (248 nm) by means of an exposure apparatus (FPA-3000EX5™, manufactured by Canon Inc.; NA=0.55, σ=0.55 and Focus Offset=−1.4 μm), and was then subjected to post-exposure bake on a hot-plate at 110° C. for 150 seconds. Thereafter, development was carried out by spray paddle with an organic alkali developing solution (AZ 300MIF™ (2.38 wt %), manufactured by AZ Electronic Materials (Japan) K.K.) at 23° C. for 1 minute. Thus, a trench pattern having an aspect ratio of 12.5 was obtained.

Resist pattern formation example 2

An 8-inch silicon wafer was subjected to HMDS (hexamethyldisilazane) treatment by means of a spin coater (MK-VIII™, manufactured by Tokyo Electron Limited), and coated with a positive-working photoresist (AZTX1701™, manufactured by AZ Electronic Materials (Japan) K.K.) by means of the same spin coater. After that, the resist was prebaked on a hot-plate at 140° C. for 150 seconds to obtain a resist layer 1 of approx. 4.0 μm thickness. The obtained resist layer was exposed to a KrF laser beam (248 nm) by means of an exposure apparatus (FPA-3000EX5™, manufactured by Canon Inc.; NA=0.55, σ=0.55 and Focus Offset=−1.4 μm), and was then subjected to post-exposure bake on a hot-plate at 110° C. for 150 seconds. Thereafter, development was carried out by spray paddle with organic alkali developing solution (AZ 300MIF™ (2.38 wt %), manufactured by AZ Electronic Materials (Japan) K.K.) at 23° C. for 1 minute. Thus, a dot pattern having an aspect ratio of 8.5 was obtained.

### Example 1

In a 1 L glass vessel, 487 g of 30 wt % aqueous solution of N-vinylpyrrolidone/hydroxyalkyl acrylate copolymer and pure water were mixed at a ratio of 2:1. To the obtained solution, 28 g of N,N-dimethoxymethyl propylene urea, 35 g of aqueous solution (16 wt %) of methoxycarbonylized polyallylamine and 0.5 g of polyoxyethylene (4) acetylenic glycol ether (Acetylenol E40™, manufactured by Kawaken Fine Chemicals Co., Ltd.) were added and stirred for 1 hour to obtain a mixed aqueous solution in which the kinetic viscosity and the ratio of the kinetic viscosity to the solid content were 24.4 mm²/s and 1.07 mm²/s/wt %, respectively.

### Example 2

The procedure of Example 1 was repeated except for replacing the aqueous solution of N-vinylpyrrolidone/hydroxyalkyl acrylate copolymer with N-vinylpyrrolidone/hydroxyalkyl methacrylate copolymer, to obtain a mixed aqueous solution in which the kinetic viscosity and the ratio of the kinetic viscosity to the solid content were 27.4 mm²/s and 1.20 mm²/s/wt %, respectively.

### Example 3

The procedure of Example 1 was repeated except for replacing the aqueous solution of N-vinylpyrrolidone/hydroxyalkyl acrylate copolymer with N-vinylpyrrolidone/vinylimidazole copolymer, to obtain a mixed aqueous solution in which the kinetic viscosity and the ratio of the kinetic viscosity to the solid content were 21.9 mm²/s and 0.96 mm²/s/wt %, respectively.

### Example 4

The procedure of Example 1 was repeated except for not adding N,N-dimethoxymethyl propylene urea, to obtain a mixed aqueous solution in which the kinetic viscosity and the ratio of the kinetic viscosity to the solid content were 23.9 mm²/s and 1.05 mm²/s/wt %, respectively.

### Example 5

The procedure of Example 1 was repeated except for not adding the aqueous solution of methoxycarbonylized polyallylamine, to obtain a mixed aqueous solution in which the kinetic viscosity and the ratio of the kinetic viscosity to the solid content were 22.8 mm²/s and 1.00 mm²/s/wt %, respectively.

### Example 6

The procedure of Example 1 was repeated except for replacing 28 g of N,N-dimethoxymethyl propylene urea with 28 g of 1,3-dimethoxymethyl-4,5-dimethoxyimidazolidine, to obtain a mixed aqueous solution in which the kinetic viscosity and the ratio of the kinetic viscosity to the solid content were 24.7 mm²/s and 1.08 mm²/s/wt %, respectively.

### Comparative Example 1

The procedure of Example 1 was repeated except for replacing the aqueous solution of N-vinylpyrrolidone/hydroxyalkyl acrylate copolymer with alkyl acetalized polyvinyl alcohol, to obtain a mixed aqueous solution in which the kinetic viscosity and the ratio of the kinetic viscosity to the solid content were 23.9 mm²/s and 3.29 mm²/s/wt %, respectively.

### Comparative Example 2

The solid content of the aqueous solution obtained in Comparative example 1 was changed to obtain a mixed aqueous solution in which the kinetic viscosity and the ratio of the kinetic viscosity to the solid content were 14.0 mm²/s and 1.62 mm²/s/wt %, s/wt %, respectively.

### Comparative Example 3

The solid content of the aqueous solution obtained in Example 3 was changed to obtain a mixed aqueous solution in which the kinetic viscosity and the ratio of the kinetic viscosity to the solid content were 3.3 mm²/s and 0.43 mm²/s/wt %, respectively.

Measurement of Covering Ratio

The aqueous solution obtained in each of Examples 1 to 6 and Comparative examples 1 to 3 was dropped in an amount of 10 cc onto the 8-inch pattern wafer obtained in each of Resist pattern formation examples 1 and 2, and spin-coated at 1000 rpm by means of a spin coater (MK-VIII™, manufactured by Tokyo Electron Limited). The samples were then baked on a hot-plate at 85° C. for 70 seconds. The sections of the obtained patterns were then observed, and thereby the patterns were evaluated and classified into the following grades:

good: the pattern was densely covered, and

poor: the pattern was crushed and poorly covered.

Further, the covering ratio of the trench pattern or dot pattern was calculated. Here, the “covering ratio” means a ratio T/D in which T and D are thicknesses of the covering layer and the resist layer, respectively, when the section of the resist pattern was observed after the baking procedure. If the fine pattern-forming composition had too small a solid content or too low a kinetic viscosity or otherwise if the composition was coated in too a small amount, the covering ratio was 1 or less and accordingly it was impossible to miniaturize the resist pattern properly. The results were as set forth in Table 1.

Measurement of Dimensional Reduction Ratio

The aqueous solution obtained in each of Examples 1 to 6 and Comparative examples 1 to 3 was dropped in an amount of 10 cc onto the 8-inch pattern wafer obtained in each of Resist pattern formation examples 1 and 2, and spin-coated at 1000 rpm by means of a spin coater (MK-VIII™, manufactured by Tokyo Electron Limited). The samples were then baked on a hot-plate at 85° C. for 70 seconds, and further heated for mixing-bake on a hot-plate at 110° C. for 70 seconds to promote the crosslinking reaction. After the crosslinking reaction was completed, development was carried out with pure water at 23° C. for 2 minutes to remove the non-crosslinked part of the covering layer. Thus, a crosslinked insoluble layer was formed on the trench pattern from the water-soluble resin. The samples were furthermore baked and dried on a hot-plate at 110° C. for 70 seconds. Each pattern was observed by scanning electron microscopy (SEM) before and after the insoluble layer was formed, and thereby dimension of the trench pattern or dot pattern was measured before and after formation of the insoluble layer, to calculate a dimensional reduction ratio in accordance with the following formula:

dimensional reduction ratio (%)=[(dimension before the insoluble layer was formed)−(dimension after the insoluble layer was formed)]/(dimension before the insoluble layer was formed)×100.

The results were as set forth in Table 1.

TABLE 1

| | v* | v/C** | Resist pattern 1 (trench pattern) | | | Resist pattern 2 (dot pattern) | | |
|---|---|---|---|---|---|---|---|---|
| | (mm²/s) | (mm²/s/wt %) | Grade | Covering ratio | Reduction ratio | Grade | Covering ratio | Reduction ratio |
| Ex. 1 | 24.4 | 1.07 | good | 1.14 | 55.0% | good | 1.22 | 48.0% |
| Ex. 2 | 27.4 | 1.20 | good | 1.06 | 43.6% | good | 1.17 | 39.1% |
| Ex. 3 | 21.9 | 0.96 | good | 1.02 | 41.9% | good | 1.10 | 37.5% |
| Ex. 4 | 23.9 | 1.05 | good | 1.10 | 27.0% | good | 1.08 | 24.0% |
| Ex. 5 | 22.8 | 1.00 | good | 1.07 | 49.3% | good | 1.01 | 45.2% |
| Ex. 6 | 24.7 | 1.08 | good | 1.18 | 41.3% | good | 1.26 | 47.6% |
| Com. 1 | 23.9 | 3.29 | poor | n/a*¹ | n/a*¹ | poor | n/a*¹ | n/a*¹ |
| Com. 2 | 14.0 | 1.62 | poor | n/a*¹ | n/a*¹ | poor | n/a*¹ | n/a*¹ |
| Com. 3 | 3.3 | 0.43 | good | 0.39 | n/a*² | good | 0.32 | n/a*² |

Remarks)
v*: kinetic viscosity
v/C**: ratio of kinetic viscosity to solid content
n/a*¹: the pattern was covered too poorly to measure the covering ratio and the dimensional reduc
n/a*²: the pattern was covered but the insoluble layer was too uneven to measure the dimensional

1. A fine pattern-forming composition containing a water-soluble resin and a water-containing solvent, characterized by having v in the range of 10 to 35 mm²/s and a ratio v/C is in the range of 0.5 to 1.5 mm²/s/wt %, wherein said v is a kinetic viscosity at 25° C. and said C is a solid content of the composition.

2. The fine pattern-forming composition according to claim 1, wherein said water-soluble resin is a copolymer comprising N-vinylpyrrolidone as a constituting unit.

3. The fine pattern-forming composition according to claim 2, wherein said water-soluble resin is a copolymer further comprising at least one constituting unit selected from the group consisting of hydroxyalkyl acrylate, hydroxyalkyl methacrylate and vinylimidazole.

4. The fine pattern-forming composition according to claim 1, wherein said water-containing solvent is a mixture of water and a water-soluble organic solvent.

5. The fine pattern-forming composition according to claim 1, characterized by further containing a water-soluble crosslinking agent.

6. The fine pattern-forming composition according to claim 5, wherein said water-soluble crosslinking agent is at least one selected from the group consisting of melamine derivatives and urea derivatives.

7. The fine pattern-forming composition according to claim 1, characterized by further containing a polyallylamine derivative.

8. The fine pattern-forming composition according to claim 1, characterized by further containing (A) an anionic surfactant, (B) a cationic surfactant or (C) a nonionic surfactant.

9. The fine pattern-forming composition according to claim 8, wherein said surfactant is at least one selected from the group consisting of (A) alkylsulfonate, alkylbenzenesulfonic acid, and alkylbenzenesulfonate; (B) laurylpyridinium chloride and laurylmethylammonium chloride; and (C) polyoxyethylene octyl ether, polyoxyethylene lauryl ether, and polyoxyethylene acetylenic glycol ether.

10. The fine pattern-forming composition according to claim 1, wherein said water-soluble resin is contained in an amount of 1 to 35 weight parts based on 100 weight parts of the composition.

11. The fine pattern-forming composition according to claim 10, wherein said water-soluble crosslinking agent is contained in an amount of 20 weight parts or less based on 100 weight parts of the composition.

12. A fine pattern-forming method comprising the steps of:
forming on a substrate a resist pattern of photoresist having an aspect ratio of 4 to 15 or having a thickness of 2 μm or more;
coating said pattern with the fine pattern-forming composition according to claim 1, to form a covering layer;
heating said covering layer and said resist pattern so as to diffuse acid from the resist pattern and thereby to crosslink and harden the covering layer in its part located near the resist pattern; and then
developing said heated covering layer with water.

13. The fine pattern-forming method according to claim 12, wherein said heating is performed at 90 to 130° C. for 50 to 90 seconds.
